(19) United States
(12) Patent Application Publication
(10) Pub. No.: US 2002/0054273 A1
(43) Pub. Date: May 9, 2002

(54) Time release cartridge for liquid scent dispenser

(76) Inventor: David A. Martin, Windermere, FL (US)

Correspondence Address: STAAS & HALSEY LLP, 700 11TH STREET, NW, SUITE 500, WASHINGTON, DC, 20001, US

(21) Appl. No.: 09/494,537

(22) Filed: Jan. 31, 2000

(51) Int. Cl. G03B 21/32

(52) U.S. Cl. 352/85; 352/40

(57) ABSTRACT

A cartridge holding a liquid scent for a liquid scent dispenser having a reservoir holding the liquid scent. An evaporation barrier at least partly surrounds the reservoir and isolates the reservoir from open air and an evaporation site member at least partly breaches the evaporation barrier and has an open air access, wherein the liquid scent evaporates away from the cartridge in molecular form toward open air.

### BACKGROUND OF THE INVENTION

1. Field of the Invention

The present invention relates to a cartridge for containing a liquid, particularly a liquid scent, used in a scent dispenser.

2. Description of the Related Art

In general, liquid scent dispensers are used for filling large spaces, such as theme park rides that move guests through small theme rooms requiring different constant scents in each room to enhance the show. Another use is for dispensing small volumes of scents individually, to seated guests at a show, for example, where scents can be changed quickly in concert with the show. Other uses of liquid scent dispensers include outside of a restaurant, inside a hospital or any other location in which it is desirable to output a constant scent.

An example of a liquid scent dispenser is shown in U.S. Pat. No. 5,898,475, the disclosure of which is herein incorporated by reference.

The liquid scent dispenser disclosed in U.S. Pat. No. 5,898,475 has a plurality of scent dispensers each having a scent release portion positioned for dispensing a scent to a predetermined area and having a source of pressurized gas connected to each scent dispenser and a gas pressure control mechanism connected between the source of pressurized gas in each of the plurality of scent dispensers and connected for receiving dispensing signals to selectively control the release of a pressurized gas, such as air, to individual scent dispensers for selectively dispersing different scents. Each selected scent dispenser is positioned adjacent the end of a pressurized gas tube and has a housing having an absorbent material therein supporting a scent absorbed in the material. The method includes the step of activating the selected scent dispenser apparatus gas pressure control mechanism to apply a predetermined volume of gas for a predetermined time period at least one gas pressure tube through the remote scent dispenser absorbent material into the air around the scent dispenser to thereby disperse a scent laced gas at a predetermined location. The gas pressure control can be computer activated to control the remote dispensing of a gas laced with scent through pulses of pressurized gas. The selected housing can also have one or more flexible membranes the ends thereof which membranes allow the escape of a scent laden gas only upon a predetermined gas pressure and otherwise blocking the egress of the scent therethrough. The selected source of air can be an oil-free air compressor or a compressed gas in a container which is remotely located and controlled to direct pressured gas through a tube to the remote scent dispenser.

In a liquid scent dispenser as described above, it is desirable to be able to change from one scent to another. However, in prior art scent dispensers, this was not possible due to the intensity of liquid scents. Such liquid scents contaminate plastic chambers by seeping into cracks and crevices and even into the plastic itself. Therefore, the plastic container will permanently take on the smell of any liquid scent with which it makes contact. That is, the first smell placed in a chamber becomes essentially a contaminating odor for any subsequent scent that goes into the same chamber. Therefore, each liquid scent dispenser, once filled with a scent, will forever be relegated to use with that particular scent.

Another problem with liquid scents is that the scent rapidly becomes seriously degraded through loss of its top notes, or more volatile constituents, and quickly becomes and unconvincing and ineffective rendition of the original scent. This is called scent instability.

### SUMMARY OF THE INVENTION

To solve the above problem, it is an object of the present invention to provide a disposable liquid scent cartridge for use with a liquid scent dispenser.

It is another object of the present invention to provide a disposable liquid scent cartridge for use without a liquid scent dispenser.

It is still a further object of the present invention to overcome the problem of scent instability.

Another object of the present invention is to provide a scent cartridge which utilizes an existent air supply.

Additional objects and advantages of the invention will be set forth in part in the description which follows and, in part, will be obvious from the description, or may be learned by practice of the invention.

To accomplish the above and other objects of the present invention, there is provided a cartridge holding a liquid scent for a liquid scent dispenser, comprising a reservoir holding the liquid scent; an evaporation barrier at least partly surrounding the reservoir and isolating the reservoir from open air; and an evaporation site member at least partly breaching the evaporation barrier and having an open air access, wherein the liquid scent evaporates away from the cartridge in molecular form toward open air.

According to another object of the present invention, there is provided a cartridge holding a liquid scent for a liquid scent dispenser, comprising a reservoir containing a pool of liquid scent and an evaporation barrier having a semi-permeable membrane completely surrounding the reservoir resulting in a liquid-tight seal preventing leakage of the liquid scent.

According to another object of the present invention, there is provided a cartridge holding a liquid scent for a liquid scent dispenser, comprising a reservoir containing a pool of liquid scent; a reservoir retaining element making contact with the reservoir and holding the liquid scent within the reservoir; and an inherent evaporation site member surrounding an outer surface of the reservoir, wherein the inherent evaporation site member includes a plurality of sheets having at least two graduated permeability constructions or varying insoluble binder percentages creating a mass-inherent evaporation regulator.

In a further embodiment, to regulate scent evaporation, the surface area of that part of the evaporation site which has access to open air is reduced. This can be accomplished in many different simple ways, as will be seen in conjunction with more specific discussion of the accompanying drawings.

In a still further embodiment of the present invention, there is provided a reservoir having absorbent material holding the liquid scent; an evaporation barrier formed by laminating the reservoir on opposing sides with evaporation barrier material, wherein a hole is formed in the laminated material to facilitate hanging the cartridge about a heating/ventilating/air conditioning outlet; and at least two slits formed in the evaporation barrier separating plural sections of said evaporation barrier thereby creating strips of evaporation barriers, wherein when the strips are pealed away from the cartridge, exposed material in said reservoir forms an evaporation site which has an open air access, wherein the liquid scent evaporates away from the cartridge in molecular form toward open air in a stable representation of the scent over time until most of the liquid scent is exhausted. Further, at least one of the plural sections can be left unlaminated, wherein the at least one of the plural sections not laminated with the evaporation barrier material serves as the evaporation site.

In addition, a remote location for the evaporation site, relative to the reservoir, can be utilized. These two parts can be connected by a conduit, which is preferably absorbent, which is referred to throughout the following description as a site extension.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is an illustration of a free liquid reservoir with an integral evaporation site according to an embodiment of the present invention;

FIG. 2 is an illustration of a captive liquid reservoir with an integral evaporation site according to another embodiment of the present invention;

FIG. 3 is an illustration of a free liquid reservoir with a remote evaporation site according to another embodiment of the present invention;

FIG. 4 is an illustration of a captive liquid reservoir with a remote evaporation site according to another embodiment of the present invention;

FIG. 5 is an illustration of a captive liquid reservoir with an inherent evaporation site according to another embodiment of the present invention;

FIG. 6 is an illustration of a replaceable captive liquid reservoir with a remote evaporation site according to another embodiment of the present invention;

FIG. 7 is an illustration of a rechargeable captive liquid reservoir with a remote evaporation site according to another embodiment of the present invention;

FIG. 8 is an illustration of a cartridge assembly according to one embodiment of the present invention;

FIG. 9 is an illustration of a cartridge assembly according to one embodiment of the present invention;

FIG. 10 is an illustration of a cartridge assembly according to one embodiment of the present invention; and

FIG. 11 is an illustration of a cartridge assembly according to one embodiment of the present invention;

FIG. 12 is an illustration of a cartridge assembly according to one embodiment of the present invention;

FIG. 13 is an illustration of a cartridge assembly according to one embodiment of the present invention;

FIG. 14 is an illustration of a cartridge assembly according to one embodiment of the present invention; and

FIG. 15 is an illustration of a cartridge assembly according to one embodiment of the present invention;

### DETAILED DESCRIPTION OF THE PREFERRED EMBODIMENTS

Preferred embodiments of the present invention will be described below in more detail with reference to the accompanying drawings.

Liquid scent mixtures are normally composed of many components, each of which have a different pressure of vaporization at any given temperature. For purpose of explanation, the chemical constituents of a smell can be divided into three simplified categories. First, there are top notes, which are those active, bright, insistent constituents which initially predominate in a smell. Second, there are middle notes, which are the next tier of constituents which can be picked out from a smell. Finally, there are bottom notes, which are those low, lingering undertone, longest lasting constituents of a smell.

It has been found that top notes characteristically have the highest pressures of vaporization and are thus the most rapidly evaporating constituents. Bottom notes will typically have the lowest pressures of vaporization and will be the slowest to evaporate. Middle notes are in between with both vapor pressure and evaporation.

When the sense of smell is used to appeal to the general population, smells which are effective with the most people are not subtle and complex, but are bold and simple. It is also believed that smell identification by most people relies largely upon the presence or absence of the top notes in that smell. Thus, with a partly depleted scent, in which bottom notes are always present, top notes are key to acceptance of the smell as the complete rendition of the scent, within the general population.

Through testing, it has been determined that exposure of a scent mixture to the open air from a reservoir was astonishingly more stable and long lasting than fully exposing the same quantity directly to the open air. One test of a bakery smell used to increase sales provided a 24 fluid ounce(FLOZ) cartridge of a fully exposed scent in direct access to a 25 cubic feet per minute(CFM) open air flow. After less than three 10-hour days, the smell was degraded to a strong but unrepresentative rendition of the original mixture, as verified by a return to flat sales. This was followed by a second test using a 28 FLOZ reservoir cartridge having ˜20% of it's surface area exposed to a 30 CFM airflow.

This increase of ˜17% more scent should have been accompanied by an increase of ˜17% CFM, to make equivalent time duration comparisons. Since we used a 20% increase in CFM, this represents a harsher test condition on the reservoir cartridge, and should have resulted in a shorter time period to become unstable (delivering an unrepresentative scent) if the reservoir cartridge were no more effective than the first cartridge.

Instead of lasting less than the original three day test, the reservoir cartridge lasted a full three weeks. While the smell had discernibly weakened, it still provided a stable and robust rendition of the original scent, as measured by a continued increase in sales. We discovered in this test that the cartridge reservoir alone accounted for the scent effect lasting >700% as long as it lasts without the reservoir.

It has been determined that there are two evaporation control mechanisms at work in the cartridge reservoir method, both of which result in much longer stable (full scent effect) cartridge life.

Setting a predetermined size of an evaporation site allows restriction of the amount of total evaporation to an effective level, and no more, thus increasing the efficiency of scent evaporation. Anything more than the effective amount of scent is in fact, wasted. The remaining unexposed scent is held in reserve behind the evaporation barrier, and feeds out onto the evaporation site at a rate determined by evaporation site size, air flow across the evaporation site, and the collective evaporation rate of the several scent constituents. The amount of scent evaporated into the airstream is stable, and decreases gradually over a long period of time. The cartridge designs deliver an inherent long-life stable scent output, a highly desirable capability not available before.

In reservoir cartridges, where top notes are continuously supplied, the evaporation site becomes a self-metering device. Continuously approximating the saturation level of the enclosed reservoir, the full range of scent notes (chemical constituents) is always being gradually fed onto the evaporation site. This means that the key recognition top notes are always being presented fresh to the evaporation site, and being continuously evaporated into the airstream, even if in a proportionally smaller quantity. The continuous supply of some top notes, even with a disproportionate quantity of the lower notes, is perceived by the general public as an acceptable rendition of the full scent. This mechanism greatly increases the longevity of scent evaporation, and ensures fragrance stability throughout the cartridge's useful life.

Generally, a liquid scent reservoir holds liquid scent in reserve at a specific location, isolated from free access to open air. An evaporation barrier, at least partly surrounding the reservoir comprises a layer of material which functions as an evaporation barrier by isolating the reservoir from free access to open air. An evaporation site is a location on the cartridge where volatile constituents of the liquid scent migrate from the reservoir to this location, and where they evaporate away from the cartridge in molecular form toward access to the open air. Intact liquid droplets, no matter how small, are never emitted from the evaporation site or the cartridge. Evaporation, or movement of scent constituents away from the cartridge is always on the molecular level, and normally of ambient temperatures (elevated temperatures are used in cold or freezing locations to simulate a higher “ambient” at the evaporation site). When the cartridge no longer emits an acceptably representative rendition of the scent, any solids and mostly a concentrate of the less volatile scent constituents are retained within the cartridge, upon the evaporation site or within the reservoir. Now referred to as residues, these constituents and the cartridge itself may be disposed of, and replaced with a fresh cartridge (or optionally, the reservoir may be recharged with the missing evaporated scent constituents).

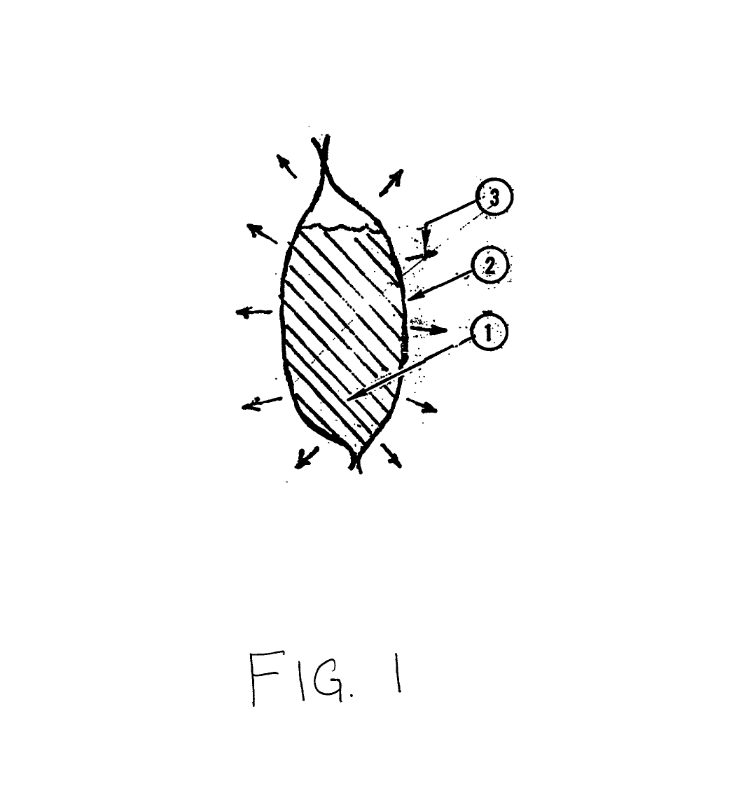

As shown in FIG. 1, there is a pool of free-liquid scent as a reservoir 1, which is completely surrounded by an evaporation barrier 2, which is a semi-permeable membrane. The evaporation barrier 2 also functions as the evaporation site, from which scent 3 will evaporate into surrounding or passing free air.

The semi-permeable membrane which makes up the evaporation barrier 2 must have a completely enclosing liquid-tight seal to prevent leakage of liquid scent. This may be accomplished with commercial heat sealing equipment. The semi-permeability of this membrane allows it to also function as the evaporation site. Various permeability rates are available for these membranes, which regulate the rate at which scent constituents may migrate through the membrane to it's outer surface, where evaporation occurs. This occurs when scent constituents evaporate into free air surrounding or passing the evaporation site.

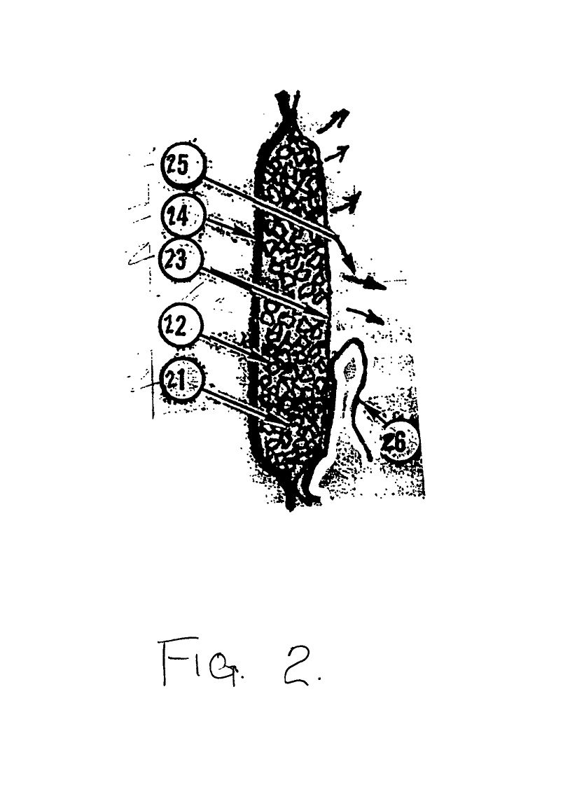

In the embodiment shown in FIG. 2, the cartridge has a pool of captive liquid scent 21 as its reservoir, surrounded by an impermeable membrane barrier 24 and a semi-permeable membrane evaporation site 23 with a partially removed regulator 26.

A reservoir retaining element 22 is made of an absorbent material which absorbs and securely holds the reservoir of liquid scent 21, so that the problem of leaking liquid scent is eliminated. Many absorbent materials may be used, such as cotton or other natural fiber, glass fiber, synthetic fiber, vermiculite, foamed silica, paper or other wood pulp, etc. Shown in FIG. 2 is a particulate form of one of these materials, where contact between particles permits migration of liquid scent through the mass.

The evaporation site 23, as shown in FIG. 2, is made of a film material, such as a semi-permeable membrane film which regulates migration of scent constituents through itself, and in part, contains the scent reservoir within it's absorbent material.

Evaporation barrier 24 is a surface which is a substantially impermeable laminated film, heat sealed to the semi-permeable membrane evaporation site 23. These films are available as a multi-ply film which can be clear, or a multi-ply laminated film which typically contains a silver colored metallized layer, usually vapor deposited aluminum. The metallized layer typically provides the most active barrier to permeability, while the other layers are structural or heat sealable layers.

Element 25 depicts the evaporating scent. In other words, scent constituents will evaporate into free air surrounding or passing by the evaporation site 23.

A regulator 26 is also shown in FIG. 2 as a partly removed layer covering the semi-permeable membrane 23. This membrane may be removed to a greater or lesser degree, and then be recovered as desired, to allow the user to regulate the amount of scent being evaporated unto the air. This material may be an adhesive backed film, or simply a loose film covering of the same or similar material used as an evaporation barrier, or an extra semi-permeable layer used to locally further restrict evaporation. It is not necessary to have intimate contact with membrane 23, or even close proximity to membrane 23, provided air movement across, or access to free-air, is largely prevented.

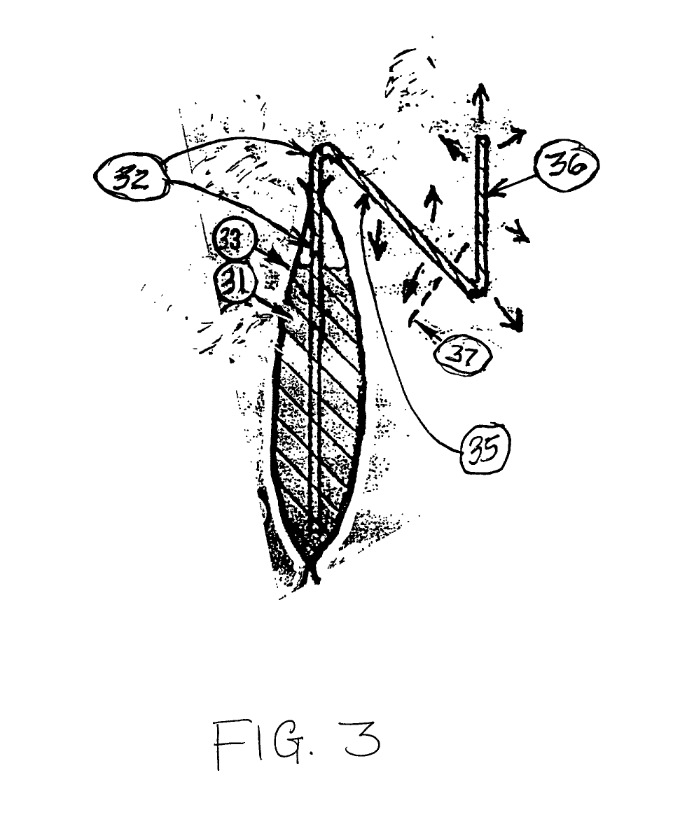

The cartridge shown in FIG. 3 has a pool of liquid scent as its reservoir 31 surrounded by an impermeable evaporation barrier 33, a remote evaporation site 35 with a partially removable site member 36 as the regulator.

As seen in FIG. 3, an evaporation site extension 32 is made of an absorbent material extending from the evaporation site material 35 into the liquid scent pool within the sealed evaporation barrier 33, and out to the evaporation site 35, which allows migration of scent constituents to the evaporation site. This can be a stranded, chord type, sheet type, or loose packed or composite particulate type of material. It may be coated or un-coated with a layer of dipped or sprayed evaporation barrier material, or it may be inserted into a preformed shape, such as a tube, which functions as a coating. It may be the same or different from the evaporation site material 35 itself. The extension material must be absorbent, and in intimate contact with the pool at one end and with the evaporation site material at the other end, but can be of any practical length in between. This allows the evaporation site to be at a considerable distance from the reservoir 31, if desired.

The evaporation barrier 33 pictured in FIG. 3 is one of the laminated film materials, heat sealed liquid-tight to completely enclose the scent pool. This can be a rigid or flexible container which allows scent constituents to be replaceable, if desired.

A liquid tight pass-through of the extension material 34 can be heat sealed, hot melt glue sealed, or compression sealed permanently or removably (as with a replaceable cap).

In contrast with FIGS. 1 and 2, the evaporation site 35 shown in FIG. 3 is non-integral to the evaporation barrier and remote from the scent pool. In this example, the extension material 32 allows migration of scent constituents to a remote site. An advantage of a non-integral site is that the material may have any number of different forms, such as stranded, sheet, chord, or even bulk materials sandwiched between screens, or otherwise constrained. This site material may be any number of absorbent materials, such as cotton or other natural fiber, glass fiber, synthetic fiber, vermiculite, paper, wood pulp, homosote, etc.

In the apparatus shown in FIG. 3, scent constituents will evaporate into free air surrounding or passing by the Evaporation Site.

The regulator function can be achieved in this embodiment by covering or removing portions of the site material 36, as cutting along a dotted line 37, thereby reducing the size of the site 35 and thus reducing overall output of evaporated scent.

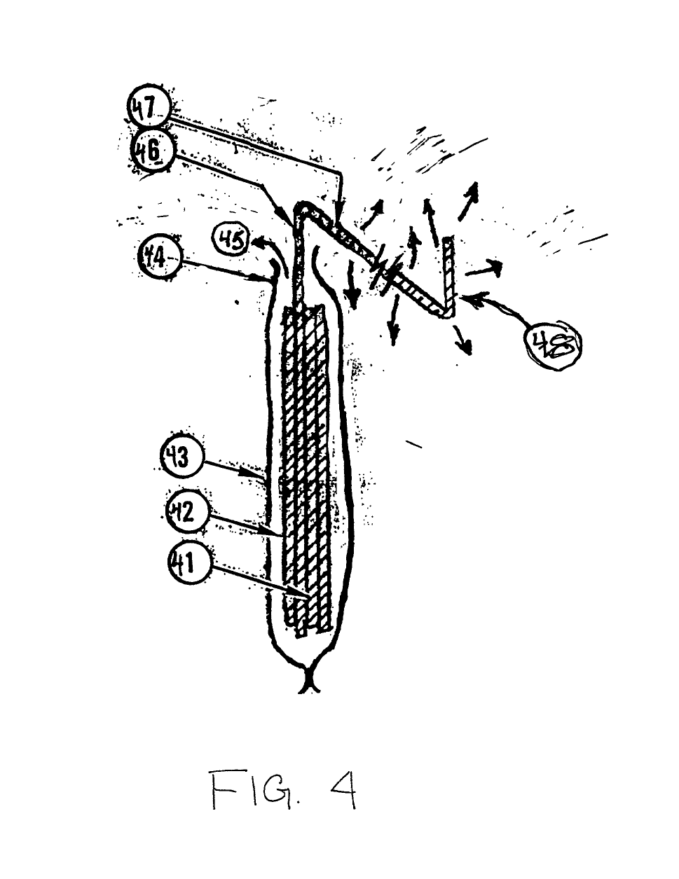

Referring to the embodiment shown in FIG. 4, this cartridge has a pool of captive-liquid scent as its reservoir 41, surrounded by an impermeable evaporation barrier 43, with a remote evaporation site 47 and a partially removable site member as the regulating mechanism 48.

A reservoir retaining element 42 is used to capture (through absorption) and hold the liquid scent securely in a “solid state” form, preventing liquid scent from leaking out of accidental openings in barrier 43. This material may be virtually any absorbent material such as cotton or other natural fibers, glass fiber, synthetic fiber, vermiculite, foamed silica, paper, wood pulp, homosote, open cell phenolic or other open cell foam plastic, etc. It can be used here in many acceptable forms, such as stranded, chord type, sheet type, or loose bulk or composite particulate type.

The evaporation barrier 43 shown in FIG. 4 is one of the laminated metallized barrier films. Further, the pass-through 44 for the extension material does not need to be sealed, since the scent liquid is in a solid state form, and does not require a seal here to contain the liquid. Some scent will evaporate 45 out from this open end of the evaporation barrier 43 under certain conditions, but it is minimal, and still subject to controlled conditions regulating access to free-air. A seal is therefore unnecessary here.

An evaporation site extension 46 is a simple extension of the evaporation site material from within the liquid scent pool captured within the reservoir retaining element, and out to the evaporation site, which allows migration of scent constituents to the evaporation site.

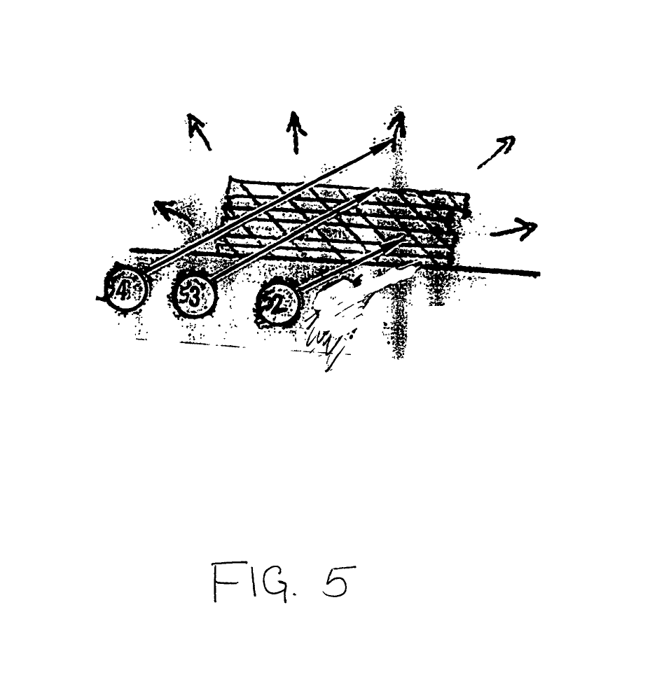

FIG. 5 shows an embodiment where the cartridge has a pool of captive liquid scent as its reservoir 52, whose outer surface is an inherent evaporation-limiting evaporation site 53. The reservoir retaining element 52 is again used to capture and hold, through absorption, the liquid scent securely in a solid state. Material as described in connection with FIG. 4 may be used here.

The outer surface of the reservoir retaining element 52 is an inherent evaporation site 53 limited by it's outer surface area. The stack of sheet materials shown are not necessarily different materials, but may have two or more graduated permeability constructions, such as open-cell sheet foam density, or varying insoluble binder percentages from sheet to sheet to enhance the evaporation barrier effect. This creates a mass-inherent evaporation regulator, rather than a surface-inherent evaporation regulator such as with the semi-permeable film materials. Scent constituents 54 will evaporate into free air surrounding or passing by the evaporation site 53.

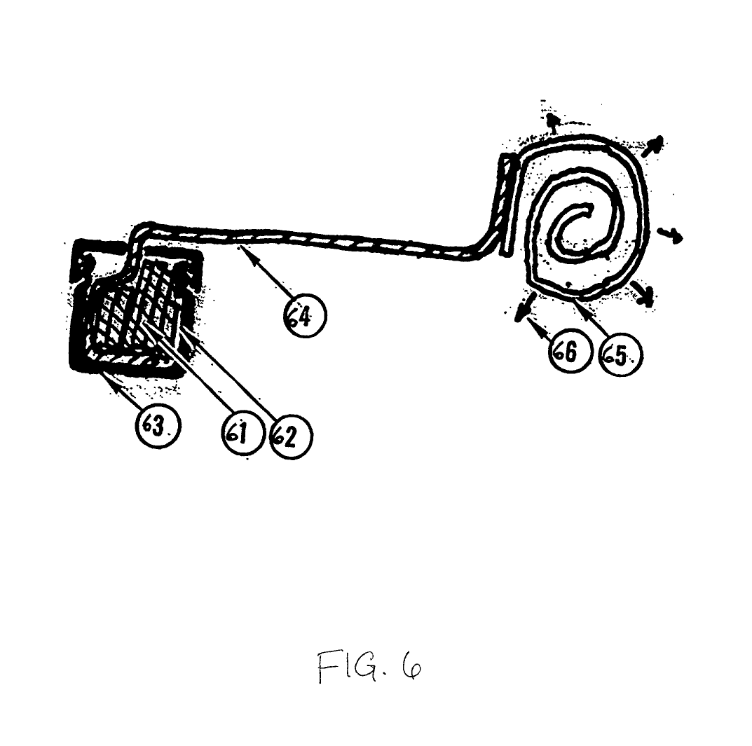

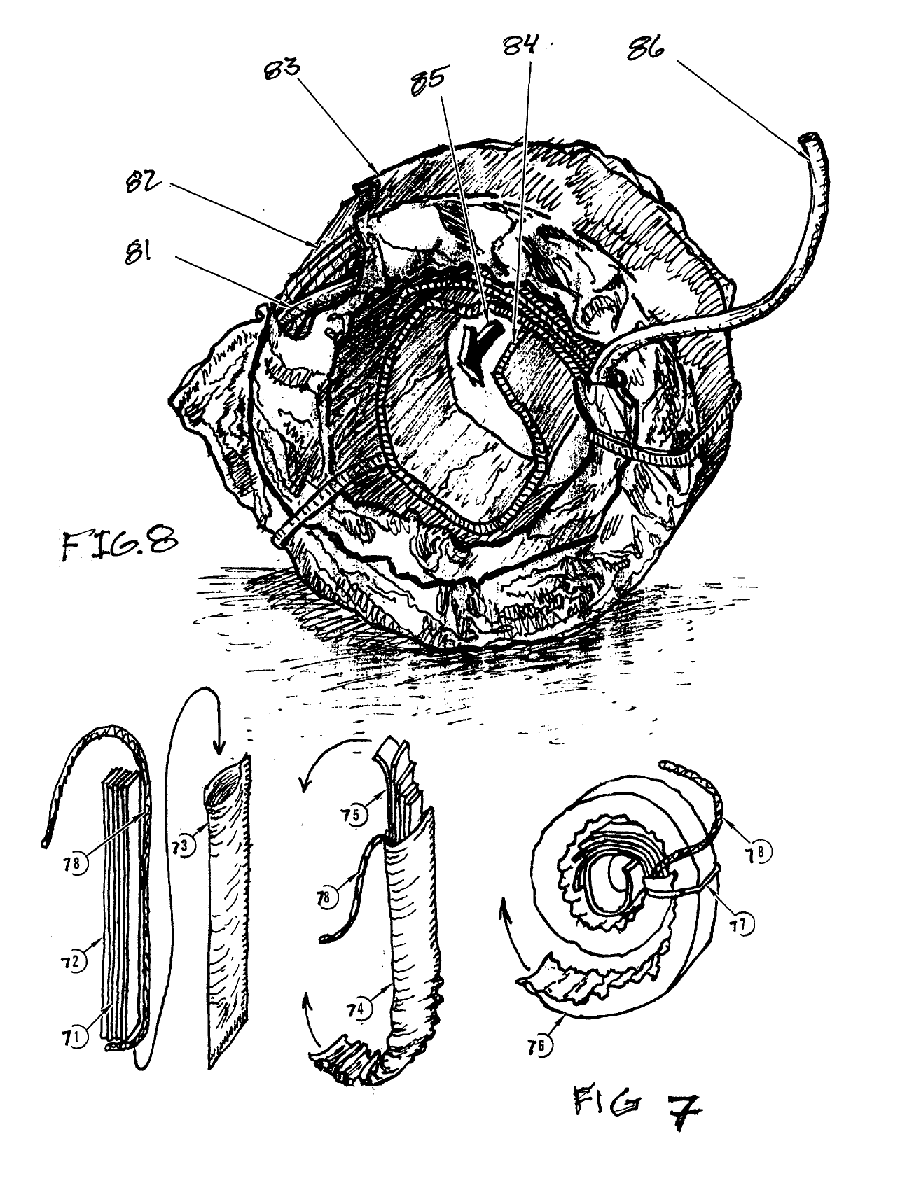

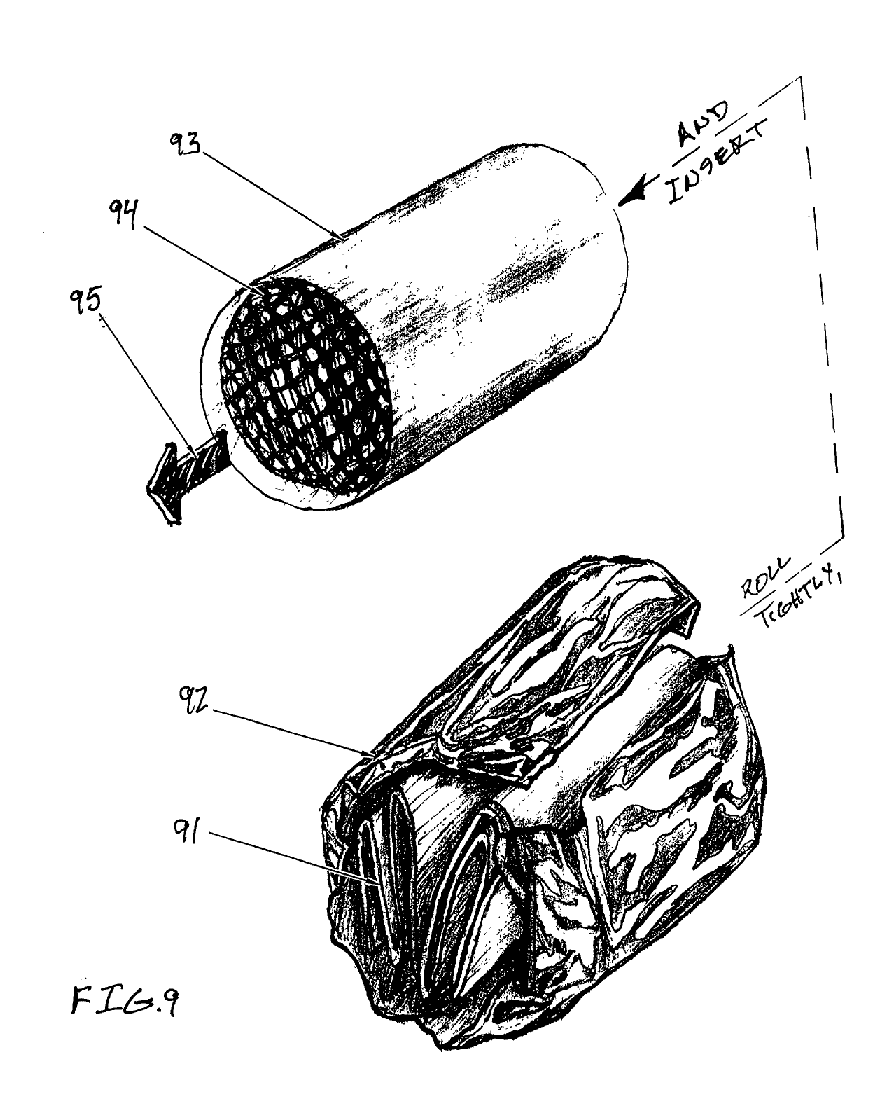

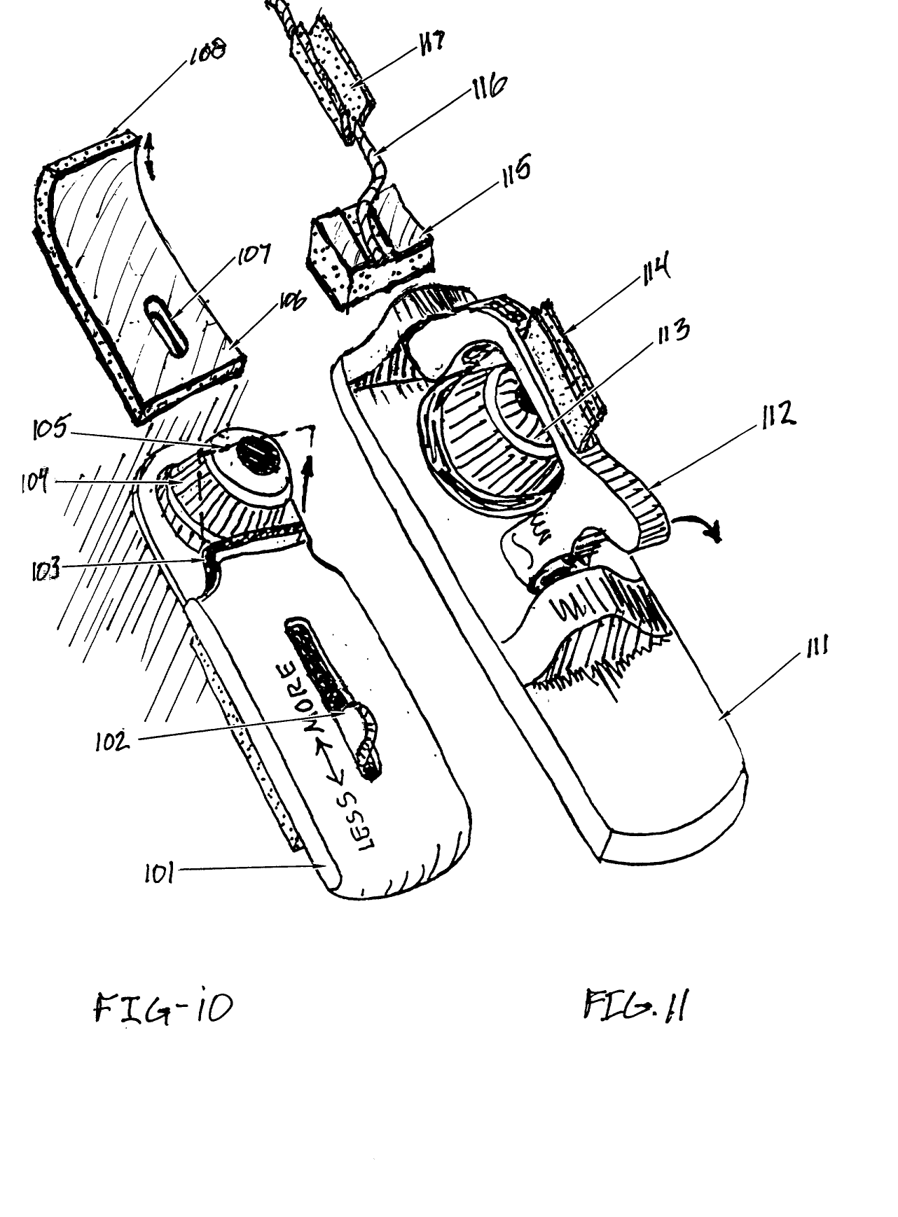

The embodiment illustrated in FIG. 6 is a replaceable captive liquid reservoir with a remote evaporation site The cartridge has a pool of captive-liquid scent as its reservoir 61, surrounded by a rigid container evaporation barrier 63, with a remote evaporation site 65.

A reservoir retaining element 62 is used to capture and hold the liquid scent securely in a solid state form. The evaporation barrier 63 is a rigid walled container with removable cover to replenish exhausted scent. Alternatively, a replaceable container could be used such as a collapsible metal tube, in which an absorbent chord-type site extension material may be removed from the exhausted tube and inserted into a fresh tube of scent as a way to replenish the scent.

The evaporation site extension 64 is made of a material different from that of both the reservoir absorbent material 61 and the evaporation site 65 and allows migration of scent constituents from the scent pool 61 to the evaporation site 65. The evaporation site 65 is made of an absorbent material which is arranged in a folded or helical shape for greater efficiency in a cylindrical scent dispenser. Scent constituents evaporate into free air 66 passing by the evaporation site 65.

FIG. 7 shows a rechargeable captive liquid reservoir with a remote evaporation site. The cartridge has a pool of captive-liquid scent as its reservoir 71, surrounded by an impermeable film evaporation barrier 73, with a rechargeable remote evaporation site 75.

As shown in FIG. 7, a reservoir retaining element 72 creates a solid-state form of the liquid scent. The evaporation barrier 73 is a sleeve made of an impermeable film material. The barrier sleeve 73 in this embodiment is coiled around the location where free-air will be blown, so that the air blown past and around evaporation site components may evaporate scent from the evaporation site.

The sheet-form scent soaked absorbent material 72 is inserted into the evaporation barrier sleeve along with a tube 78, which is to be employed later in replenishing exhausted scent material. Some of the reservoir retaining element 75 protrudes here from the sleeve, and in this embodiment, protrudes farther as the sleeve covered reservoir is coiled. This protruding material shall become the evaporation site, and is coiled in such a way as to create gaps and spaces between the exposed sheet material pieces. The reservoir coil may be tied to itself to keep its shape (represented as element 77 in FIG. 7).

An optional injection tube 78 feeds from the bottom of the reservoir retaining element 75, through the coil, and extends out of the open end of the barrier sleeve 73. After the cartridge becomes exhausted through use, this tube may be connected to an injection device. The cartridge may be recharged by injecting fresh liquid scent constituents into the tube, where they will be absorbed by the partially dried out reservoir retaining element 72. Refilling with this tube arrangement will be most efficient, since liquid will fill all sleeve folds and creases from the closed end of the sleeve, pushing air out as it goes. A measured amount should be injected so that liquid scent does not drip out the open sleeve end, which must be oriented at the “top”, or at “12 o'clock”, it's highest position. After injection, the scent is quickly absorbed into the reservoir retaining element 72. Whole scent, or a mixture of only the exhausted scent constituents can be re-injected. Both would work, but the cartridge will last longer and take more recharges if only the exhausted constituents are injected.

FIG. 8 is a representation of a completed cartridge assembly which is essentially the cartridge shown in FIG. 7 as it looks when assembled. Element 81 represents an optional tube which is located inside the barrier sleeve material 83. The liquid scent reservoir 82 is contained within the absorbent reservoir retaining elements. The liquid scent can be refilled by using the refill tube 86. As air approaches the cartridge, it flows in the direction of the arrow represented by element 85.

FIG. 9 is a cartridge similar to the one shown in FIG. 8. The length of this cartridge has been increased along the direction of the air flow in order to multiply the size of the liquid fragrance reservoir. Ties 77, which are employed in the cartridge shown in FIG. 7 (also shown in FIG. 8) in order to maintain the assembled shape, are replaced in this embodiment by a cartridge outer liner 93. The coiled cartridge is inserted into the external liner 93, which has a mesh opening at both ends to permit easy air flow through the cartridge. The evaporation site 91 is exposed to the air flowing through the cartridge. The film evaporation barrier 92 encloses the liquid scent reservoir, which is held within the absorbent reservoir retaining elements and intimately connected to the evaporation site pieces 91. The cartridge components are rolled tightly and then inserted into the external liner 93, where tightly rolled components unroll slightly to fit tightly within the external liner 93. An open mesh screen 94 is attached to both air input and the air output ends of the cartridge liner 93 to securely hold the cartridge within the liner 93. The liner 93 makes it very easy to extract spent cartridges from a mechanical air supply unit. The scent laden forced air is output from the air output end in the direction of arrow 95.

While the above described embodiment is designed for use with a dispenser device which supplies the air, it should be appreciated that these cartridges are adaptable to be used in applications were the air supply is already present. This type of cartridge has the same functional parts described above, i.e., liquid scent reservoir held in absorbent reservoir retaining element, evaporation barrier, evaporation site, evaporation site extension member, and regulator.

An example of such an embodiment is shown in FIG. 10. The cartridge illustrated in FIG. 10 can be used in a passenger aircraft lavatory, where small round ventilator control nozzles are standard equipment. This cartridge uses a housing 101 with a hole for the ventilator nozzle to protrude therethrough. The cartridge itself can be slid back and forth with an adjustment lever 102, so that more or less of the evaporation site is exposed to direct air flow impingement from the air exiting the nozzle 104. This allows the scent concentration to be changed at will. The cartridge housing 101 can be attached to the aircraft bulkhead with an adhesive backing, for example. The underside 108 of the cartridge 106 serves as the evaporation site. An evaporation barrier is laminated on top and bottom sides of the absorbent material. Full extension of the cartridge 106 is represented by element 105. A slot 107 is provided in the cartridge 106 where the lever 102 protrudes through from a back side of the cartridge 106.

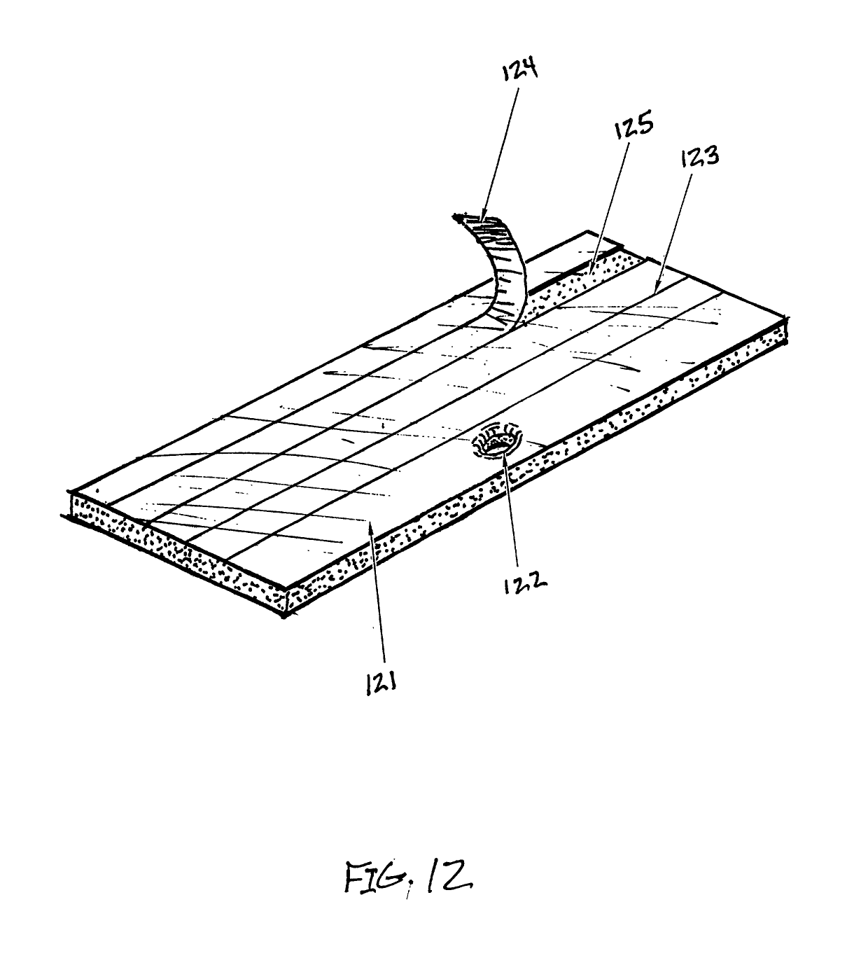

An alternative design for such a device to be used in a aircraft lavatory, for example, is illustrated in FIG. 11. Shown here is a cartridge housing 111 with adhesive backing adhering the housing 111 to the aircraft bulkhead. The reservoir resides beneath this location. An adjustment bail 112 is shown in an air impingement position. The bail 112 can be flipped partly or fully in a down position (in direction of arrow shown), thereby changing exposure to air impingement and amount of scent evaporation into the air. Ventilator nozzle 113, protrudes from the aircraft bulkhead with the hole in cartridge housing centered around the nozzle. The evaporation site 114 is located in a position over the air flow from nozzle. The reservoir has an evaporation barrier 115 laminated to both sides, except where the evaporation site extension 116 is in intimate contact with the reservoir. This site extension 116 is an absorbent rope-like material and feeds from the reservoir up through the bail 112 to the evaporation site 114, allowing rotation of the bail 112 without interrupting scent migration to the evaporation site 114. Evaporation site material 117 folds around site extension material 116 and is inserted into the bail slot.

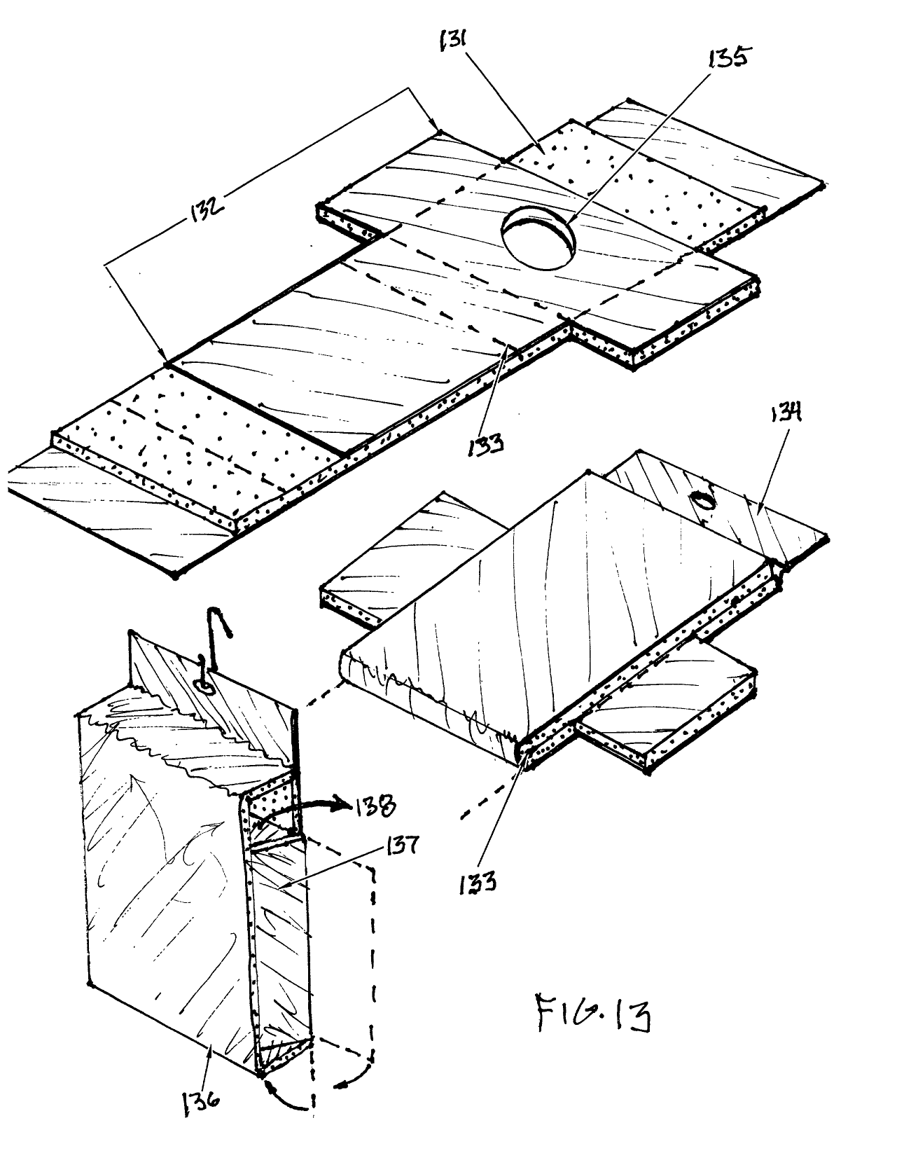

In the embodiment shown in FIG. 12, the cartridge is designed to be hung in front of heating/ventilating/air conditioning(HVAC) outlets commonly found in buildings and vehicles. The scent reservoir 121 contained within absorbent material is laminated on both sides with the evaporation barrier material. A hole 122 may be punched somewhere in this laminate to hang the cartridge in front of the HVAC outlet. Two or more slits 123 may be made in the evaporation barrier, separating sections from the barrier film. Alternately, circles or other shapes can be cut into the barrier film material. The strips 124 (or shapes) may be peeled off the reservoir. When strips are removed from the film, the exposed reservoir material becomes the evaporation site 125. The intensity of scent released is regulated by the number of strips 124 peeled off.

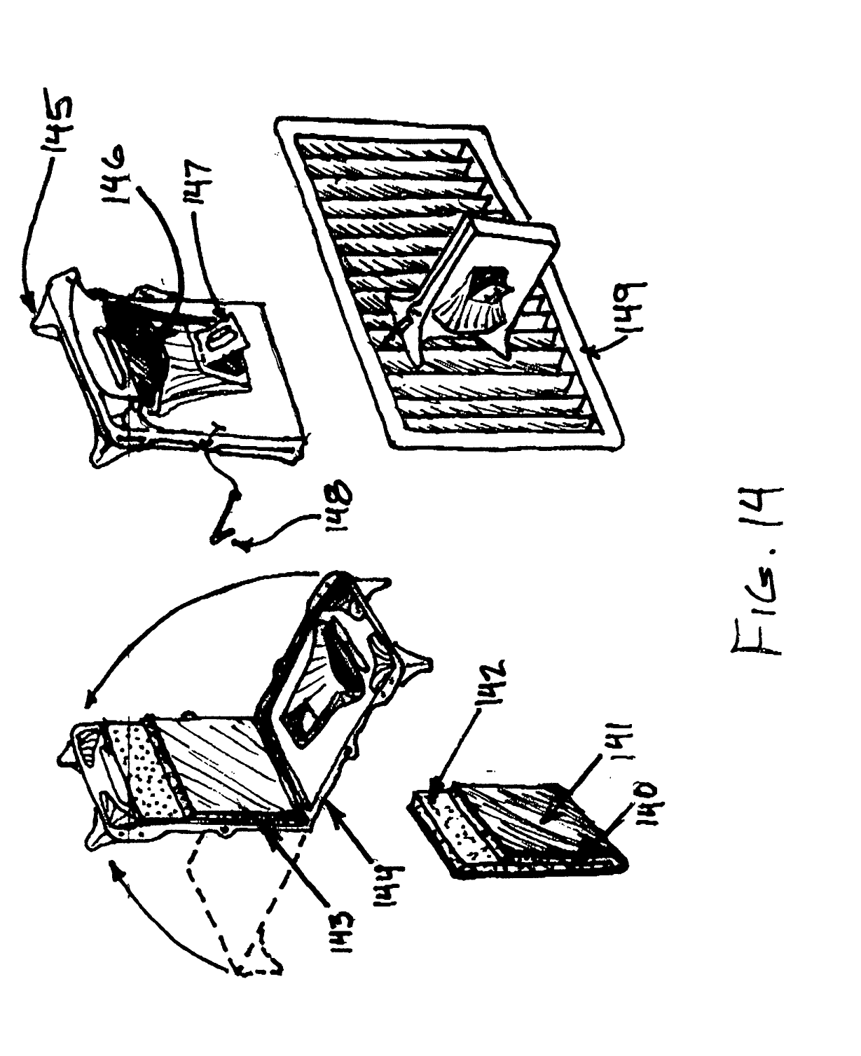

FIG. 13 shows an alternate HVAC cartridge which can be sold flat and opened before use. The scent reservoir 131 is laminated on both sides with evaporation barrier film material. Some sections are not laminated entirely on one side. These sections will become evaporation sites. Enclosed area 132 is laminated on both sides. Dotted lines on the assembly are creases. The assembly is folded in half along crease 133. The loose flaps 134 at top and bottom of the upper drawing are laminated together. A hole 135 is punched in the side which will be against the HVAC outlet during use. To prepare the cartridge for use, the unit 136 is folded open, along the internal creases. Both side flaps 137 are folded into the internal gap formed when folded open. The flaps will hold the unit open for air circulation past the internal evaporation sites. Air 138 circulating into the cartridge through the hole 135 will evaporate scent from the internal evaporation sites and exit the cartridge here, above the flaps on both sides.

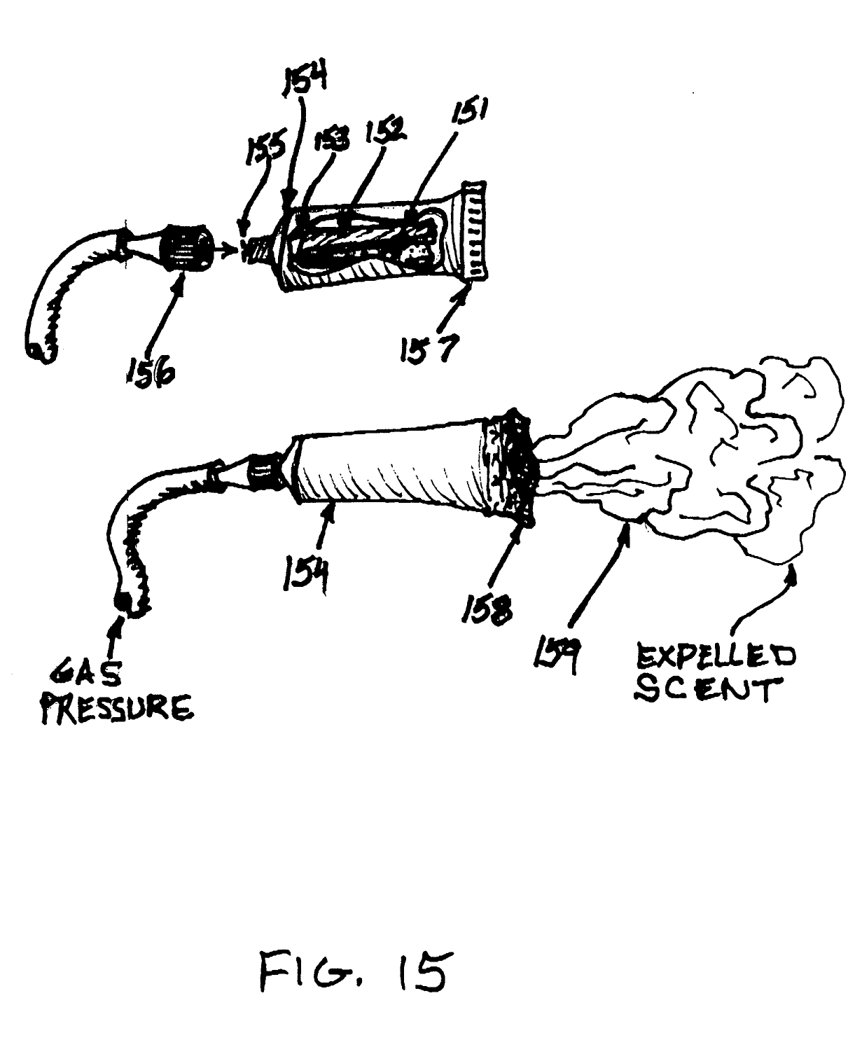

FIG. 14 is an illustration of the cartridge assembly shown in FIG. 12, which has been modified to have a barrier film 141 on one side only of the reservoir 140, then folded to have an exposed reservoir section which will become an evaporation site 142.

As shown in FIG. 14, the finished cartridge 143 fits into a molded cavity of a plastic or paper housing, such as vac-u formed polypropylene 144, for example. The housing folds around the cartridge and provides features such as stabilizing legs 145 which orient the assembly against an HVAC grate. A three-dimensional cowling 146 redirects the existing air flow for more efficient passage across the evaporation site 142. An optional regulator, such as door 147, can control the volume of scent-laden output air. A common attachment means, such as hooks 148 on elastic chord must be provided for mounting the unit. The final unit assembly 149 is mounted upon a common HVAC grate, where the cowling scoops and concentrates passing air into impingement against the evaporation site and out the open output door.

FIG. 15 is an illustration of yet another embodiment of the present invention in which the scent delivery is pressure activated.

A cartridge with a reservoir 151 and heat-sealable barrier material 152, used principally to physically hold the reservoir material intact within an aluminum tube, is applied on one side of the reservoir material and can fold over wire 153. Hooks in the end of the wire protrude through a threaded opening 155 of tube 154, so that the hooks prevent the cartridge from blowing out of tube 154 during use. Alternatively, the cartridge can be made too wide to be passable through a pressure-opened crimp seal. A cap having a hose 56 is screwed onto the tube 154. The tube 154 is crimp-sealed at 157. The unit can be stored in this configuration for the shelf-life of the scent materials. When gas pressure is applied through the cap into tube 154, the crimp seal at 157 will unfold (as seen at 158), opening enough to let the scent be expelled, as at 159.

While only certain embodiments of the invention have been specifically described herein, it will be apparent that numerous modifications may be made thereto without departing from the spirit and scope of the invention.

What is claimed is:

1. A replaceable cartridge holding a liquid scent, comprising:
a reservoir holding the liquid scent;
an evaporation barrier at least partly surrounding the reservoir and isolating the reservoir from open air; and
an evaporation site member at least partly breaching the evaporation barrier and having an open air access, wherein the liquid scent evaporates away from the cartridge in molecular form toward open air in a stable representation of the scent over time until most of the liquid scent is exhausted.

2. The cartridge as claimed in claim 1, further comprising a regulator regulating scent evaporation by reducing a surface area of the open air access.

3. The cartridge as claimed in claim 1, further comprising a reservoir retaining element contacting the reservoir and made of an absorbent material which absorbs and holds the liquid scent in the reservoir.

4. The cartridge as claimed in claim 2, wherein the regulator is a removable layer covering the evaporation site member and a user can regulate an amount of scent evaporated into the air by removing or adding at least a portion of the removable layer.

5. The cartridge as claimed in claim 3, further comprising an evaporation site member extension connecting the evaporation site member to the cartridge, wherein the evaporation site member is separate from the cartridge.

6. The cartridge as claimed in claim 5, wherein the evaporation site member extension is made of an absorbent material and allows migration of scent constituents to the evaporation site member.

7. The cartridge as claimed in claim 5, wherein the evaporation site member extension has a first end making contact with a pool of the liquid scent in the reservoir and a second end making contact with the evaporation site member.

8. The cartridge as claimed in claim 7, wherein the evaporation barrier is an impermeable membrane and the evaporation site member is partially removable to regulate evaporation of the scent constituents.

9. The cartridge as claimed in claim 1, wherein a permeability rate of the evaporation barrier regulates a rate at which scent constituents from the liquid scent migrate through the evaporation barrier to an outer surface of the evaporation barrier where evaporation of the scent constituents occurs.

10. The cartridge as claimed in claim 1, wherein the evaporation site member is at least partially removable to regulate an amount of scent evaporated into the air.

11. The cartridge according to claim 1, further comprising:
a cartridge housing having a hole capable of receiving an external ventilator nozzle and capable of being mounted to a surface; and
an adjustment lever to slide the cartridge in and out of said cartridge housing, thereby varying an amount of said evaporation site member which is exposed to air flow.

12. A replaceable cartridge holding a liquid scent, comprising:
a reservoir having absorbent material holding the liquid scent;
an evaporation barrier formed by laminating the reservoir on opposing sides with evaporation barrier material, wherein a hole is formed in the laminated material to facilitate hanging the cartridge about a heating/ventilating/air conditioning outlet; and
at least two slits formed in the evaporation barrier separating plural sections of said evaporation barrier thereby creating strips of evaporation barriers, wherein when the strips are peeled away from the cartridge, exposed material in said reservoir forms an evaporation site which has an open air access, wherein the liquid scent evaporates away from the cartridge in molecular form toward open air in a stable representation of the scent over time until most of the liquid scent is exhausted.

13. The cartridge claimed in claim 12, wherein the strips can be comprised of varying shapes.

14. A cartridge holding a liquid scent, comprising:
a reservoir containing a pool of liquid scent;
a reservoir retaining element making contact with the reservoir and holding the liquid scent within the reservoir; and
an inherent evaporation site member at least partly breaching an outer surface of the reservoir, wherein the inherent evaporation site member includes a plurality of sheets having at least two graduated permeability constructions or varying insoluble binder percentages creating a mass-inherent evaporation regulator and the liquid scent evaporates away from the cartridge in molecular form toward open air in a stable representation of the scent over time until most of the liquid scent is exhausted.

15. The cartridge as claimed in claim 5, wherein the evaporation barrier is a rigid walled container with a removable cover allowing the reservoir to be refilled.

16. The cartridge as claimed in claim 15, wherein
the evaporation barrier is a collapsible metal tube in which the evaporation site member extension may be removed from an exhausted metal tube and inserted into a fresh metal tube,
the evaporation site member extension is made of a material which is different than a material making up the reservoir and a material making up the evaporation site member, and
the material of the evaporation site member is arranged in a folded or helical shape.

17. A cartridge holding a liquid scent for a liquid scent dispenser, comprising:
a reservoir holding a pool of captured liquid scent;
a reservoir retaining element creating a solid-state form of the liquid scent;
an evaporation barrier surrounding the reservoir retaining element and forming a sleeve of impermeable film material; and
an evaporation site having a sheet form of an absorbent material soaked by the liquid scent and being inserted into the evaporation barrier sleeve, wherein the sleeve of the evaporation barrier coils around a location where free air will blow so that the air may evaporate scent from the evaporation site and the liquid scent evaporates away from the cartridge in molecular form toward open air in a stable representation of the scent over time until most of the liquid scent is exhausted.

18. The cartridge as claimed in claim 17, further comprising an injection tube which feeds from a bottom of the reservoir retaining element through the evaporation barrier coils and then out of an open end of the evaporation barrier sleeve and which may be recharged by injecting fresh liquid scent into the tube where it will be absorbed by the reservoir retaining element.

19. The cartridge as claimed in claim 17, wherein the cartridge is coiled and inserted into an external liner, the external liner having a mesh opening at opposite ends facilitating air flow through the cartridge.

20. A cartridge for holding a liquid scent for use with a liquid scent dispenser, comprising:
means for containing a pool of liquid scent; and
means for preventing leakage of the liquid scent surrounding the means for containing the pool of liquid scent, wherein the liquid scent evaporates away from the cartridge in molecular form toward open air in a stable representation of the scent over time until most of the liquid scent is exhausted.

21. The cartridge as claimed in claim 12, wherein at least one of the plural sections are not laminated with the evaporation barrier material, the at least one of the plural sections not laminated with the evaporation barrier material serving as the evaporation site.

22. The cartridge as claimed in claim 1, wherein the evaporation barrier is an impermeable membrane and the evaporation site member is a semi-permeable membrane.

23. The cartridge as claimed in claim 12, further comprising a three-dimensional cowling around the cartridge redirecting and concentrating an existing air flow efficiently across the evaporation site.

24. The cartridge as claimed in 17, wherein the evaporation barrier is a collapsible aluminum tube having a crimp-seal at one end, the aluminum tube inflated by a supplied air-flow, wherein the supplied air flow will inflate the aluminum tube so as to reopen the crimp-seal supplying the scent in a stable representation of the scent over time until most of the liquid scent is exhausted.
